(19) United States
(12) Patent Application Publication
(10) Pub. No.: US 2014/0111523 A1
(43) Pub. Date: Apr. 24, 2014

(54) VARIABLE LENGTH ANIMATIONS BASED ON USER INPUTS

(71) Applicant: Google Inc., (US)

(72) Inventor: Jerome F. SCHOLLER, San Francisco, CA (US)

(73) Assignee: Google Inc., Mountain View, CA (US)

(21) Appl. No.: 13/657,772

(22) Filed: Oct. 22, 2012

(51) Int. Cl. G06T 13/00

(52) U.S. Cl. 345/473

(57) ABSTRACT

A computer-implemented method for transition animation is disclosed according to one aspect of the subject technology. The method comprises determining a user's level of experience using an application, determining a duration of a transition animation based on the user's determined level of experience, and playing the transition animation for the determined duration.

### FIELD

The subject disclosure generally relates to computing devices, and, in particular, to variable length animations based on user inputs.

### BACKGROUND

A computing device may display transition animation when an action is performed on the computing device to visually indicate to the user the action being performed and/or the result of the action. For example, when a new tab is opened on a browser, the computing device may play transition animation showing the corresponding page rotating into the screen (e.g., right to left) to visually indicate to the user that the page corresponds to the new tab. As another example, when an application window is minimized, the computing device may play transition animation showing the application window shrinking into a restore button to visually indicate to the user that the application window has been minimized and can be restored by clicking the restore button. Thus, transition animation visually indicates to the user what is happening on the computing device and/or how things are linked together.

Transition animation can be useful in helping a new user learn how to use a new application. However, an experienced user may find the transition animation annoying. This is because the experienced user may not need the transition animation to understand what is happening on the computing device. In addition, the experienced user may not be able to interact with the computing device while the transition animation is playing and become frustrated.

### SUMMARY

A computer-implemented method for transition animation is disclosed according to one aspect of the subject technology. The method comprises determining a user's level of experience using an application, determining a duration of a transition animation based on the user's determined level of experience, and playing the transition animation for the determined duration.

A machine-readable medium comprising instructions stored therein is disclosed according to an aspect of the subject technology. The instructions, which when executed by a machine, cause the machine to perform operations for transition animation. The operations comprise determining a user's level of experience using an application, and determining a duration of a transition animation based on the user's determined level of experience. The operations also comprise determining when a computing device is to perform an action in response to a user input, and, upon determining that the computing device is to perform the action, playing the transition animation for the determined duration.

A system for transition animation is disclosed according to an aspect of the subject technology. The system comprises one or more processors, and a machine-readable medium comprising instructions stored therein, which when executed by the one or more processors, cause the one or more processors to perform operations. The operations comprise receiving user inputs to an application, determining a user's level of experience using the application based on the user inputs, determining a duration of a transition animation based on the user's determined level of experience, and playing the transition animation for the determined duration.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several embodiments of the subject technology are set forth in the following figures.

FIGS. 1A-1C show an example of a transition animation indicating the opening of a new tab.

FIGS. 2A-2C show an example of a transition animation indicating minimizing of an application window.

FIGS. 3A-3C show an example of a transition animation indicating switching between two images in an image gallery.

FIG. 4 is a flow diagram of a method for transition animation according to an aspect of the subject technology.

FIG. 5 conceptually illustrates an electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

A computing device may display transition animation when an action is performed on the computing device to visually indicate to the user the action being performed and/or the result of the action. For example, when a new tab is opened on a browser, the computing device may display transition animation showing the corresponding page rotating into the screen (e.g., right to left) to visually indicate to the user that the page corresponds to the new tab. As another example, when an application window is minimized, the computing device may display transition animation showing the application window shrinking into a restore button to visually indicate to the user that the application window has been minimized and can be restored by clicking the restore button. Thus, transition animation visually indicates to the user what is happening on the computer and/or how things are linked together.

Transition animation can be useful in helping a new user learn how to use a new application. However, an experienced user may find the transition animation annoying. This is because the experienced user may not need the transition animation to understand what is happening on the computing device. In addition, the experienced user may not be able to interact with the computing device while the transition animation is playing and become frustrated.

The subject technology addresses this problem by determining a user's level of experience with an application, and adjusting the duration of a transition animation based on the user's determined level of experience. If the user is determined to be experienced, then the duration of the transition animation may be shortened. If the user is determined to be inexperienced (e.g., a beginner), then the duration of the transition animation may be increased. Thus, the transition animation may be played slower for an inexperienced user to help the inexperienced user learn how to use the application, and may be played faster for an experienced user so that the experienced user can interact with the application device faster.

A user's level of experience using an application may be determined using a variety of different methods. For example, the user's level of experience may be determined based on a frequency of user inputs to the application. The higher the frequency of user inputs, the more experienced the user may be considered.

In another example, the user's level of experience may be determined based on a number of user inputs to the application. A larger number of user inputs may indicate that the user has spent a larger amount of time using the application, and therefore has become more experienced at using the application. Thus, the larger the number of user inputs, the more experienced the user may be considered.

In yet another example, the user's level of experience may be determined based on an overall usage duration for the application. A lager application usage duration may indicate that the user has spent a larger amount of time using the application, and therefore has become more experienced at using the application. Thus, the larger the application usage duration, the more experienced the user may be considered.

The above examples for determining the user's level of experience are discussed in greater detail below according to various aspects of the subject technology.

After determining the user's level of experience, the determined level of experience may be saved in a user profile. When the user uses the application, the duration of a transition animation for the application may be adjusted based on the user's level of experience in the user profile. The higher the user's level of experience, the shorter the duration of the transition animation, and the lower the user's level of experience, the longer the duration of the transition animation.

Examples of transition animations that may be used in various aspects of the subject technology will now be described.

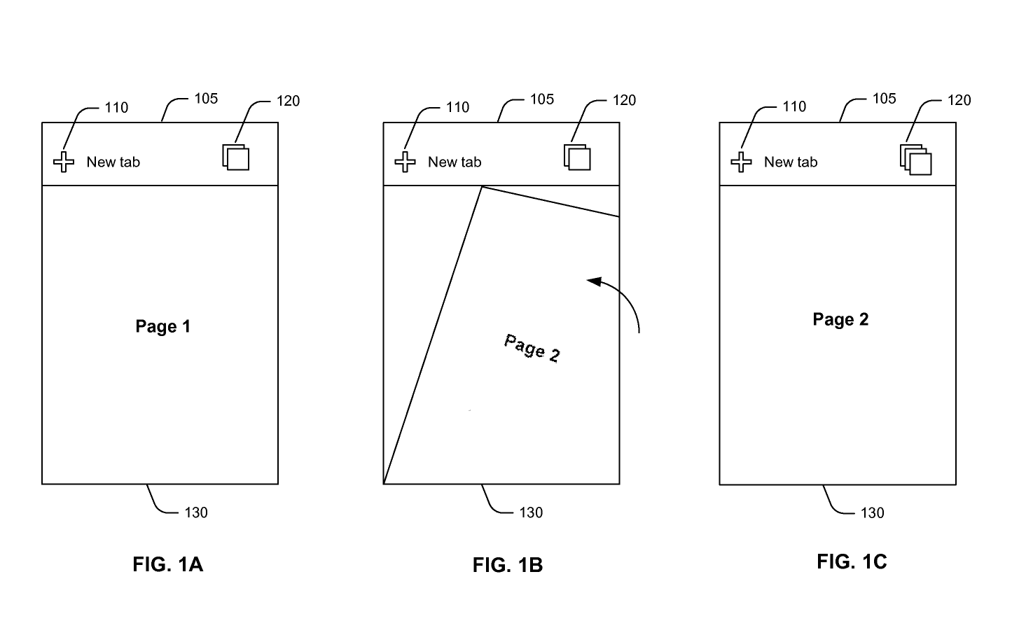

FIGS. 1A-1C show an example of a transition animation visually indicating the opening of a new tab in a browser 105. The graphical user interface of the browser 105 includes a new tab button 110, a switch tab button 120, and a browser window 130. In FIG. 1A, “page 1” of a currently opened tab is displayed in the browser window 130. The user may open a new tab by clicking or tapping the new tab button 110. This user input triggers the browser 105 to open a new tab and play the transition animation to visually indicate the opening of the new tab. In this regard, FIG. 1B shows “page 2,” which corresponds to the new tab, rotating into the browser window 130 as part of the transition animation. The arrow in FIG. 1B indicates the direction of the rotation. FIG. 1C shows “page 2” of the new tab in the browser window 130 after the transition animation is finished. Thus, the transition animation visually indicates to the user that “page 2” corresponds to the new tab, and therefore indicates the relationship between the new tab and “page 2.”

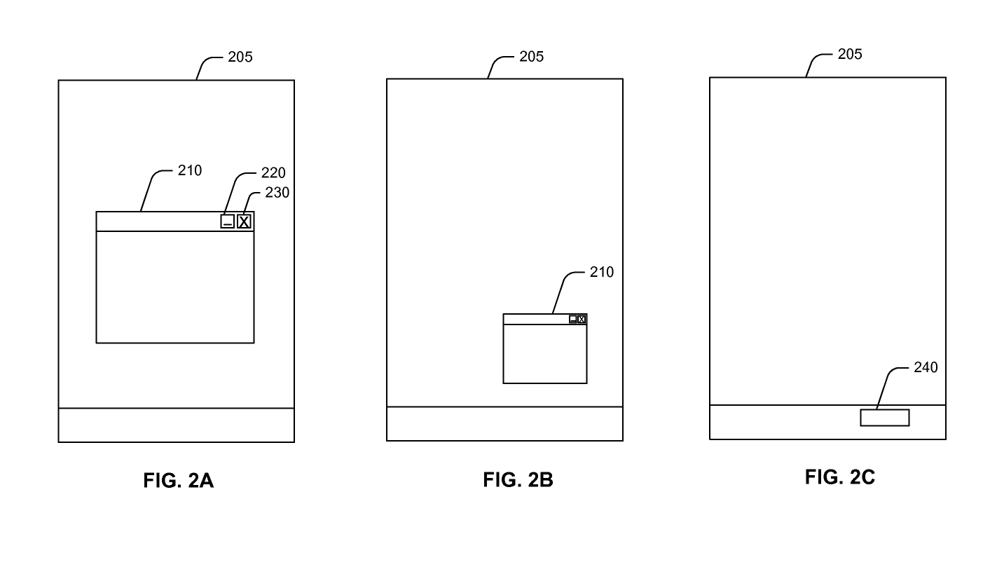

FIGS. 2A-2C show an example of a transition animation visually indicating minimizing of an application window 210 on a display 205. The application window 210 includes a minimize button 220 for minimizing the application and a close button 230 for closing the application. The user may minimize the application window 210 by clicking the minimize button 220. This user input triggers the computing device to minimize the application window 210 and play the transition animation to visually indicate the minimizing of the application window 210. In this regard, FIG. 2B shows the application window 210 shrinking into a restore button 240 (shown in FIG. 2C) as part of the transition animation. Thus, the transition animation visually indicates to the user that the application has been minimized and can be restored by clicking the restore button 240.

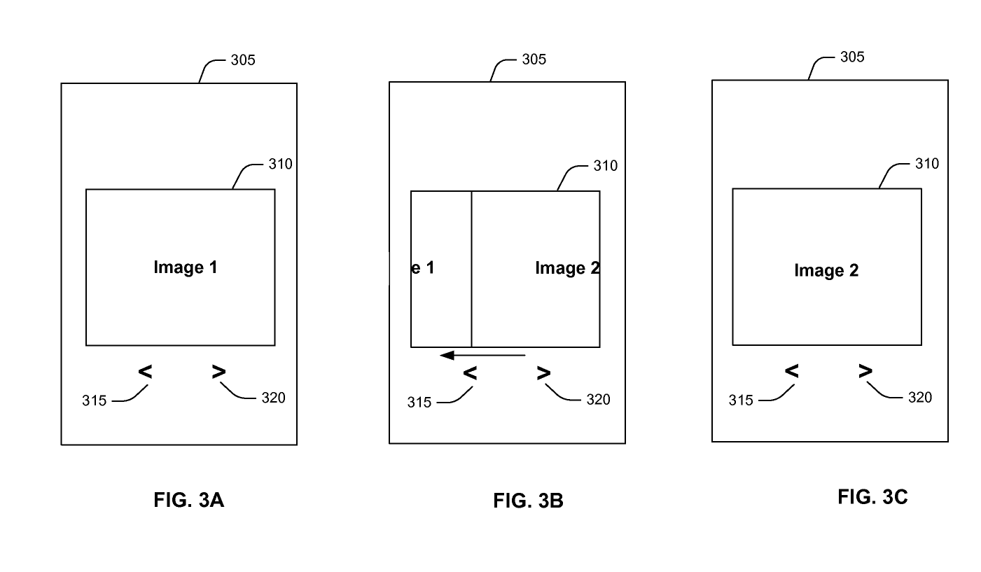

FIGS. 3A-3C show an example of a transition animation visually indicating switching between images in an image gallery on a display 305. In this example, the image currently selected by the user is displayed in a view window 310, as shown in FIG. 3A. The user may navigate to other images in the image gallery, e.g., by clicking arrow buttons 315 and 320. When the user switches to the next image in the image gallery, e.g., by clicking arrow button 320, the transition animation is played to visually indicate the switch. FIG. 3B shows an example of the transition animation, in which the current image (labeled “image 1”) slides out of the view window 310 and the next image (labeled “image 2”) slides into the view window. The arrow in FIG. 3B indicates the direction of the slide. It is to be appreciated that other types of animation may be used to visually indicate the switch between images. For example, the switch may be visually indicated by fading out the current image and fading in the next image, and/or morphing the current image into the next image. FIG. 3C shows the next image (labeled “image 2”) in the view window 310 after the transition animation is finished.

Thus, when a user input triggers the computing device to perform an action (e.g., open a new tab), a transition animation can be played to visually indicate to the user the action being performed and/or the result of the action. The duration of the transition animation may be, e.g., a few hundredths to a few seconds. In one aspect, the duration of the transition animation may be specified by a duration setting that can be adjusted based on the user's level of experience. Various methods for determining the user's level of experience are described below.

In one aspect, the user's level of experience may be determined based on the frequency of user inputs to an application. For a browser application, the user inputs may include opening a new tab, removing a tab, adding a new bookmark, changing browser settings (e.g., preferred search engine, theme, etc.), navigating to a URL, and/or other user inputs that change a state of the browser application. For an image editing application, the user inputs may include cropping, painting, rotating, drawing and/or other user inputs that manipulate an image being edited or otherwise change a state of the image editing application. For a word processing application, the user inputs may include selecting a font, selecting a paragraph format, copying text and/or other user inputs that manipulate a document being edited or otherwise change a state of the word processing application.

When the application is running on the computing device, a program may detect user inputs to the application, and compute a frequency of user inputs based on the detected user inputs. The frequency of user inputs may be a number of detected user inputs per unit of time.

In one example, the program may only count user inputs that fall within a certain set of user inputs. The set of user inputs may comprise user inputs that are considered to be indicative of the user's level of experience and/or change a state of the application. The set of user inputs may be selected by a programmer, an administrator, and/or the user, and stored on the computing device. As a result, the program does not count (filters out) user inputs that are outside the set of user inputs. User inputs that are outside the set of user inputs may be considered inputs that are not indicative of the user's level of experience (e.g., a user input that simply moves a pointer or cursor on the screen).

After determining the frequency of user inputs, the program may determine the user's level of experience based on the frequency of user inputs. A higher level of user experience may be determined for a higher frequency of user inputs. For example, different levels of user experience may be assigned to different frequency ranges, in which a higher level of user experience is assigned to a higher frequency range than a lower frequency range. In this example, a program may determine within which frequency range the determined frequency of user inputs belongs, and assign the user to the corresponding level of user experience.

In another aspect, the user's level of experience may be determined based on the number of user inputs to the application. When the application is running on the computing device, a program may detect user inputs to the application, and compute a number of the detected user inputs. The number of detected user inputs may be a total number of detected user inputs over a period of time. In one aspect, the program may only count user inputs that fall within a certain set of user inputs (e.g., user inputs considered to be indicative of the user's level of experience), as discussed above.

After determining the number of user inputs, the program may determine the user's level of experience based on the number of user inputs. A higher level of user experience may be determined for a larger number of user inputs. For example, different levels of user experience may be assigned to different number ranges, in which a higher level of user experience is assigned to a higher number range than a lower number range. In this example, a program may determine within which number range the determined number of user inputs belongs, and assign the user to the corresponding level of user experience.

In another aspect, the user's level of experience may be determined based on the overall application usage duration. In this aspect, a program on the computing device may detect when the application is running on the computing device, and record a total amount of time that the application is run on the computing device over a period of time. In one example, the application usage duration may be equal to the total amount of time that the application is run on the computing device.

In another example, the program may detect when the application is running in the foreground and the background on the computing device. The application may run in the foreground when the application is maximized and/or the application is displayed on top of another application in a desktop environment. The application may run in the background when the application is minimized and/or another application is displayed on top of the application in a desktop environment. In this example, when determining the application usage duration, the program may not count the time that the application is run in the background. This is because the user may not interact with the application when the application is running in the background, and therefore may not gain experience using the application during this time.

In this aspect, the user's experience level may be determined as a function of the application usage duration. A higher level of user experience may be determined for a larger application usage duration. For example, different levels of user experience may be assigned to different ranges of application usage durations, in which a higher level of user experience is assigned to a higher range than a lower range. In this example, a program may determine within which range the determined application usage duration belongs, and assign the user to the corresponding level of user experience.

In another aspect, the user's level of experience may be determined using a combination of two or more of the methods discussed above. For example, a level of user experience may be determined based on a first one of the methods (e.g., frequency of user inputs), and a level of user experience may be determined based on a second one of the methods (e.g., application usage duration). In this example, the user's level of experience may be computed as an average or a weighted sum of the two levels of user experience.

After determining the user's level of experience, the determined level of experience may be saved in a user profile. When the user uses the application, the duration of a transition animation for the application may be adjusted based on the user's level of experience in the user profile. The higher the user's level of experience, the shorter the duration of the transition animation, and the lower the user's level of experience, the longer the duration of the transition animation.

The application may run on a computing device (e.g., laptop, mobile phone, etc.) used by the user. When the user uses the application on the computing device, the computing device may determine the user's level of experience, as discussed above. The computing device may then store the user's level of experience in a user profile on the computing device. The computing device may also send the user's level of experience to a server via a network, in which the server stores the user's level of experience in a user profile on the server. In this example, when the user uses the same application on another computing device, the server may send the user's level of experience to the other computing device via a network. The other computing device may then adjust the duration of a transition animation for the application based on the received user's level of experience.

In one aspect, a transition animation may have an initial duration setting specifying how long the transition animation is to be played. The initial duration setting may correspond to a default level of experience. When the user's determined level of experience is above the default level of experience, the duration setting for the transition animation may be shortened (decreased) from the initial duration setting. The amount by which the duration setting for a transition animation is shortened from the initial duration setting may depend on the amount by which the user's level of experience exceeds the default level of experience. The duration setting for the transition animation may be shortened by a greater amount when the user's level of experience exceeds the default level of experience by a greater amount.

When the user's determined level of experience is below the default level of experience, the duration setting for the transition animation may be lengthened (increased) from the initial duration setting. The amount by which the duration setting for the transition animation is lengthened from the initial duration setting may depend on the amount by which the user's level of experience is below the default level of experience. The duration setting for the transition animation may be lengthened by a greater amount when the user's level of experience is below the default level of experience by a greater amount.

In one aspect, the user's level of experience may be regularly updated. For example, the user's level of experience may be updated each time the user runs the application. The user's level of experience may also be updated periodically and/or when a certain number of new user inputs are received. When the user's level of experience is updated, the duration setting for the transition animation may be adjusted accordingly. Thus, the duration setting for the transition animation may decrease over time as the user gains more experience using the application.

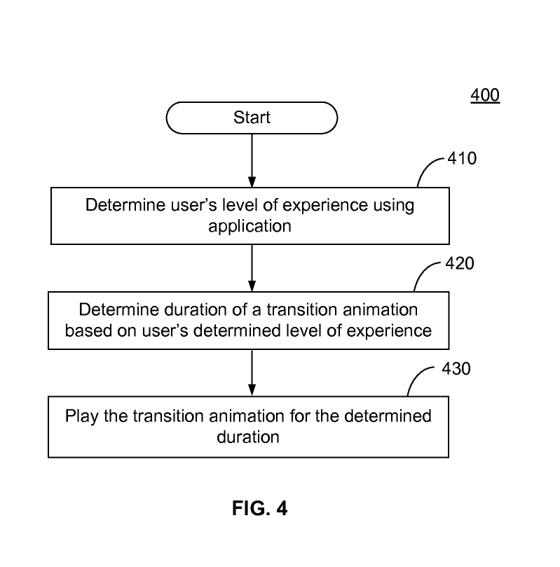

FIG. 4 shows a flow diagram of a method 400 for transition animation according to an aspect of the subject technology.

In step 410, the user's level of experience using an application is determined. For example, the user's level of experience may be determined based on a frequency of user inputs, a number of user inputs and/or application usage duration.

In step 420, a duration of a transition animation is determined based on the user's determined level of experience. For example, the higher the user's level of experience, the shorter the duration of the transition animation.

In step 430, the transition animation is played for the determined duration. For example, the transition animation may be played when the user enters an input that triggers the computing device to perform an action that is visually indicated by the transition animation.

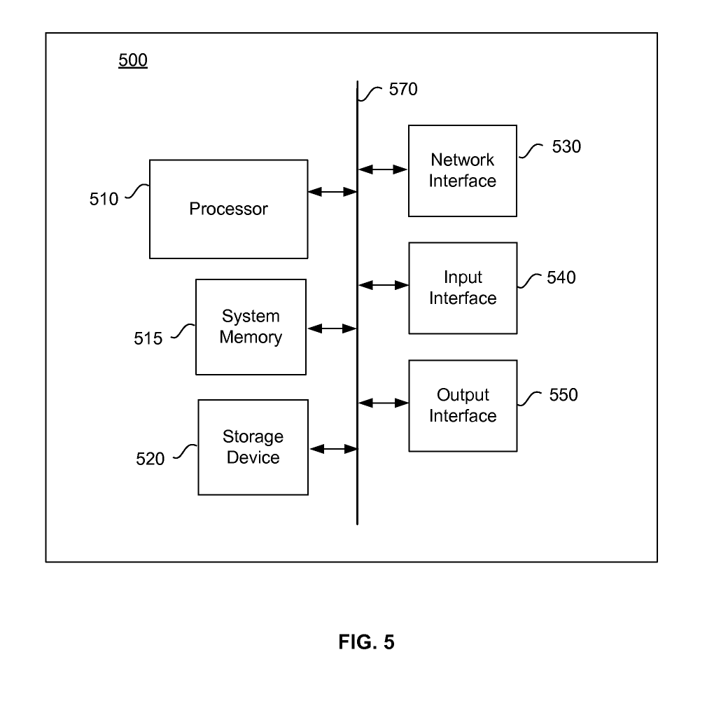

FIG. 5 conceptually illustrates an electronic system 500 with which some implementations of the subject technology are implemented. While the electronic system 500 is shown in one configuration in FIG. 5, it is to be understood that the electronic system 500 may include additional, alternative and/or fewer components.

In the example shown in FIG. 5, the electronic system 500 includes a processor 510, system memory 515, a storage device 520, a network interface 530, an input interface 540, an output interface 550, and a bus 570. The bus 570 collectively represents all system, peripheral, and chipset buses that communicatively connect the numerous components of the electronic system 500. For instance, the bus 570 communicatively connects the processor 510 with the system memory 515 and the storage device 520. The processor 510 may retrieve instructions from one or more of these memories and execute the instructions to implement processes according to various aspects of the subject technology. The processor 510 may comprise a single processor or a multi-core processor in different implementations.

The storage device 520 may comprise a solid state drive, a magnetic disk, or an optical drive. The storage device 520 may be used to store an operating system (OS), programs, and/or files. The system memory 515 may comprise volatile memory (e.g., a random access memory (RAM)) for storing instructions and data that the processor 510 needs at runtime. Instructions for performing processes according to various aspects of the subject technology may be stored in the storage device 520 and loaded into the system memory 515 during runtime for execution by the processor 510.

For example, the duration setting for a transition animation and the user's level of experience may be stored in the storage device 520 and loaded into the system memory 515 during runtime for use by the processor 510. The processor 510 may update the user's level of experience in the system memory 515 (e.g., based on new user inputs), and store the updated user's level of experience in the storage device 520 for long term storage. In addition, when the processor 510 updates the user's level of experience, the processor 510 may also update the duration setting for the transition animation in the system memory 515 accordingly, and store the updated duration setting in the storage device 520 for long term storage. When the user enters an input causing the processor 510 to perform an action that is visually indicated by the transition animation, the processor 510 may play the transition animation for the duration specified by the duration setting.

The network interface 530 enables the processor 510 to communicate over a network (e.g., a local area network (LAN), a wide area network (WAN), an intranet, the Internet, etc.). The network interface 530 may include a wireless communication module for communicating with a base station or wireless access point connected to a network over a wireless link (WiFi wireless link, cellular wireless link, etc.). For example, the network interface 530 may be used to send the user's level of experience to a server and/or receive the user's level of experience from a server.

The input interface 540 enables the user to communicate information and commands to the processor 510. For example, the input interface 540 may be coupled to an alphanumeric keyboard and/or a pointing device (e.g., touch pad or mouse) to receive commands from the user.

The output interface 550 enables the processor 510 to communicate information to the user. For example, the output interface 550 may be coupled to a display (e.g., liquid crystal display (LCD)) to output information from the processor 510 to the user.

Many of the above-described features and applications may be implemented as a set of machine-readable instructions stored on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this disclosure, the term “software” and “program” is meant to include firmware or applications stored in a memory, which can be executed by a processor. Also, in some implementations, multiple software aspects can be implemented as sub-parts of a larger program while remaining distinct software aspects. In some implementations, multiple software aspects can also be implemented as separate programs. Finally, any combination of separate programs that together implement a software aspect described here is within the scope of the disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computers and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical things that store information in a form that is readable by a computer. These terms exclude any wireless signals, wired download signals, and any other ephemeral signals.

It is understood that any specific order or hierarchy of steps in the processes disclosed is an illustration of exemplary approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method for transition animation, the method comprising:
determining a user's level of experience using an application;
determining a duration of a transition animation based on the user's determined level of experience; and
playing the transition animation for the determined duration.

2. The method of claim 1, wherein determining the user's level of experience comprises:
determining a frequency of user inputs; and
determining the user's level of experience based on the frequency of the user inputs.

3. The method of claim 1, wherein determining the user's level of experience comprises:
determining a number of user inputs; and
determining the user's level of experience based on the number of user inputs.

4. The method of claim 1, wherein determining the user's level of experience comprises:
determining usage duration for the application; and
determining the user's level of experience based on the usage duration for the application.

5. The method of claim 1, wherein determining the user's level of experience comprises:
receiving user inputs;
determining which of the user inputs fall within a set of user inputs;
determining a frequency of the user inputs that fall within the set of user inputs; and
determining the user's level of experience based on the frequency of the user inputs that fall within the set of user inputs.

6. The method of claim 1, wherein determining the user's level of experience comprises:
receiving user inputs;
determining which of the user inputs fall within a set of user inputs;
determining a number of the user inputs that fall within the set of user inputs; and
determining the user's level of experience based on the number of user inputs that fall within the set of user inputs.

7. The method of claim 1, wherein the transition animation visually indicates at least one of opening of a new tab, minimizing of an application window, and switching between two images.

8. A machine-readable medium comprising instructions stored therein, which when executed by a machine, cause the machine to perform operations for transition animation, the operations comprising:
determining a user's level of experience using an application;
determining a duration of a transition animation based on the user's determined level of experience;
determining when a computing device is to perform an action in response to a user input; and
upon determining that the computing device is to perform the action, playing the transition animation for the determined duration.

9. The machine-readable medium of claim 8, wherein the transition animation visually indicates that the action is being performed by the computing device.

10. The machine-readable medium of claim 9, wherein the action comprises at least one of opening of a new tab, minimizing of an application window, and switching between two images.

11. The machine-readable medium of claim 8, wherein the transition animation visually indicates a result of the action on the computing device.

12. The machine-readable medium of claim 8, wherein determining the user's level of experience comprises:
determining a frequency of user inputs; and
determining the user's level of experience based on the frequency of the user inputs.

13. The machine-readable medium of claim 8, wherein determining the user's level of experience comprises:
determining a number of user inputs; and
determining the user's level of experience based on the number of user inputs.

14. The machine-readable medium of claim 8, wherein determining the user's level of experience comprises:
determining usage duration for the application; and
determining the user's level of experience based on the usage duration for the application.

15. A system for transition animation, the system comprising:
one or more processors; and
a machine-readable medium comprising instructions stored therein, which when executed by the one or more processors, cause the one or more processors to perform operations comprising:
receiving user inputs to an application;
determining a user's level of experience using the application based on the user inputs;
determining a duration of a transition animation based on the user's determined level of experience; and
playing the transition animation for the determined duration.

16. The system of claim 15, wherein determining the user's level of experience comprises:
determining a frequency of the user inputs; and
determining the user's level of experience based on the frequency of the user inputs.

17. The system of claim 15, wherein determining the user's level of experience comprises:
determining a number of the user inputs; and
determining the user's level of experience based on the number of user inputs.

18. The system of claim 15, wherein the operations further comprise:
determining when a computing device is to perform an action in response to a user input;
wherein the transition animation is played for the determination duration upon determining that the computing device is to perform the action.

19. The system of claim 18, wherein the transition animation visually indicates that the action is being performed by the computing device.

20. The system of claim 19, wherein the action comprises at least one of opening of a new tab, minimizing of an application window, and switching between two images.
